(19) United States
(12) Patent Application Publication
(10) Pub. No.: US 2007/0112833 A1
(43) Pub. Date: May 17, 2007

(54) System and method for annotating patents with MeSH data

(75) Inventors: Robert L. Angell, Salt Lake City, UT (US); Stephen K. Boyer, San Jose, CA (US); James W. Cooper, Wilton, CT (US); Richard A. Hennessy, Austin, TX (US); Tapas Kanungo, San Jose, CA (US); Jeffrey T. Kreulen, San Jose, CA (US); David C. Martin, San Jose, CA (US); James J. Rhodes, San Jose, CA (US); W. Scott Spangler, San Martin, CA (US); Herschel J.R. Weintraub, Peoria, AZ (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/281,290

(22) Filed: Nov. 17, 2005

(51) Int. Cl. G06F 7/00

(52) U.S. Cl. 707/102

(57) ABSTRACT

A system and method for enhancing patent documents. A system is disclosed that includes: an extraction system for extracting non-patent references from a patent document; a system for cross-referencing an extracted non-patent reference with a metadata database to identify metadata information associated with the extracted non-patent reference; and a system for annotating the patent document with the metadata information.

### BACKGROUND OF THE INVENTION

1. Technical Field

The present invention relates generally to annotating documents such as patents, and more specifically relates to a system and method for annotating patents with MeSH data.

2. Related Art

Recent years have seen an explosive growth in the field of biotechnology, where discoveries can be worth hundreds of millions of dollars for the entities that own the rights to the discoveries. An ongoing challenge however is the tremendous cost of the research and development that is typically required. Given the dollar figures that are involved, obtaining, enforcing, and in many cases avoiding biotechnology patents has become an extremely important endeavor for companies in almost all biological sciences fields.

To be successful, companies must have a full understanding of the patent landscape for a particular biotechnology field. Existing patents and patent publications provide a great deal of information that can be used by companies when making decisions regarding investments of resources, avoiding potential infringement, understanding the state of the art, etc. Methodologies for identifying related patents are well known. A common approach involves word searching, in which key words are entered into a database to identify patents that include those terms. Another approach includes identifying related patents based on the classification and sub-classification codes that are designated to each patent. In even a further approach, investigators can examine the list of cited references found on each patent to identify related patents.

While each of these techniques is valid, each is limited for obvious reasons. Word searching is limited since different patent drafters often refer to similar concepts using any number of different terms, which generates many useless results. Furthermore, the number of patents that share the same classification/sub-classification codes can be very large in number, and not always include the relevant features that are being searched. Conversely, the number of prior art references listed on a patent is typically a relatively short list, which may provide a good starting point, but is almost certainly not comprehensive in nature.

Accordingly, there are currently significant limitations involved in searching and analyzing patent literature when trying to understand the patent landscape of a particular field of study.

Fortunately, non-patent literature in the biotechnology field is somewhat more user-friendly. The US National Library of Medicine (NLM) has over the years developed a scientific system called the Universal Medical Language System (UMLS) for the international harmonization of medical information and for the purpose of improving access to medical and scientific literature. The UMLS (http://umls.nlm.nih.gov/) objective is to help researchers intelligently retrieve and integrate information from a wide range of disparate electronic biomedical information sources. It can be used to overcome variations in the way similar concepts are expressed in different sources. This makes it easier for users to link information from patient record systems, bibliographic databases, factual databases, expert systems, etc.

The UMLS knowledge services can also assist in data creation and indexing publications. A part of the UMLS consists of the Medical Subject Heading (MeSH) Codes which serve as the basis for building ontology's important for the classification of the scientific literature. To this end, the NLM has a full time staff who methodically index millions of scientific publications in practically all of the recognized scientific journals. This forms the bases of such national resources such as MedLine (as well as other databases). When the NLM indexers classify and index these journals they do it using the MeSH ontology and in so doing create an extremely valuable set of metadata that describes the articles being indexed. For example, the indexers typically read the articles and make a list of all chemicals that are mentioned in the articles (i.e., the chemical file).

At the highest level, the indexers use a variety of MeSH qualifier codes to determine if the article being indexed is about chemicals, surgery, genetics, etc. At the more granular level, they classify the articles via an extensive system of concept codes, which number more than 750,000. This serves as a rich source of metadata for further classifying and indexing other content.

Unfortunately, patent documents are not indexed by the NLM, or any similar system. Accordingly, a need exists for a system that can incorporate a standardized knowledge base and ontology, such as that provided by the NLM, into the patent literature.

### SUMMARY OF THE INVENTION

The present invention addresses the above-mentioned problems, as well as others, by providing a system and method of incorporating NLM indexing information into existing patent literature as metadata.

In a first aspect, the invention provides a system for enhancing a patent document, comprising: an extraction system for extracting non-patent references from a patent document; a system for cross-referencing an extracted non-patent reference with a metadata database to identify metadata information associated with the extracted non-patent reference; and a system for annotating the patent document with the metadata information.

In a second aspect, the invention provides a computer program product stored on a computer usable medium for enhancing a patent document, comprising: program code configured for extracting non-patent references from a patent document; program code configured for cross-referencing an extracted non-patent reference with a metadata database to identify metadata information associated with the extracted non-patent reference; and program code configured for annotating the patent document with the metadata information.

In a third aspect, the invention provides a method of enhancing a patent document, comprising: extracting non-patent references from a patent document; cross-referencing an extracted non-patent reference with a metadata database to identify metadata information associated with the extracted non-patent reference; and annotating the patent document with the metadata information.

In a fourth aspect, the invention provides a method for deploying patent enhancement application, comprising: providing a computer infrastructure being operable to: extract non-patent references from a patent document; cross-reference an extracted non-patent reference with a metadata database to identify metadata information associated with the extracted non-patent reference; and annotate the patent document with the metadata information.

In a fifth aspect, the invention provides computer software embodied in a propagated signal for implementing a patent enhancement system, the computer software comprising instructions to cause a computer to perform the following functions: extract non-patent references from a patent document; cross-reference an extracted non-patent reference with a metadata database to identify metadata information associated with the extracted non-patent reference; and annotate the patent document with the metadata information.

The invention thus allows a user to better analyze patents and patent applications and more easily review the patent landscape of different biotechnology topics and fields, and also determine areas of opportunity for future patents. Additionally, by annotating the patents with important MeSH and MeSH like qualifier codes, the invention could be used to assist in finding important prior art related to a particular patent or invention. The invention allows for the analysis of patents at various levels, including a molecular level, which, e.g., is based on the molecular structures of chemicals mentioned in the related art journals, as opposed to what simply appears in the text of the patent.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a patent annotation system in accordance with an embodiment of the present invention.

FIG. 2 depicts search engine for searching annotated patents accordance with an embodiment of the present invention.

### DETAILED DESCRIPTION OF THE INVENTION

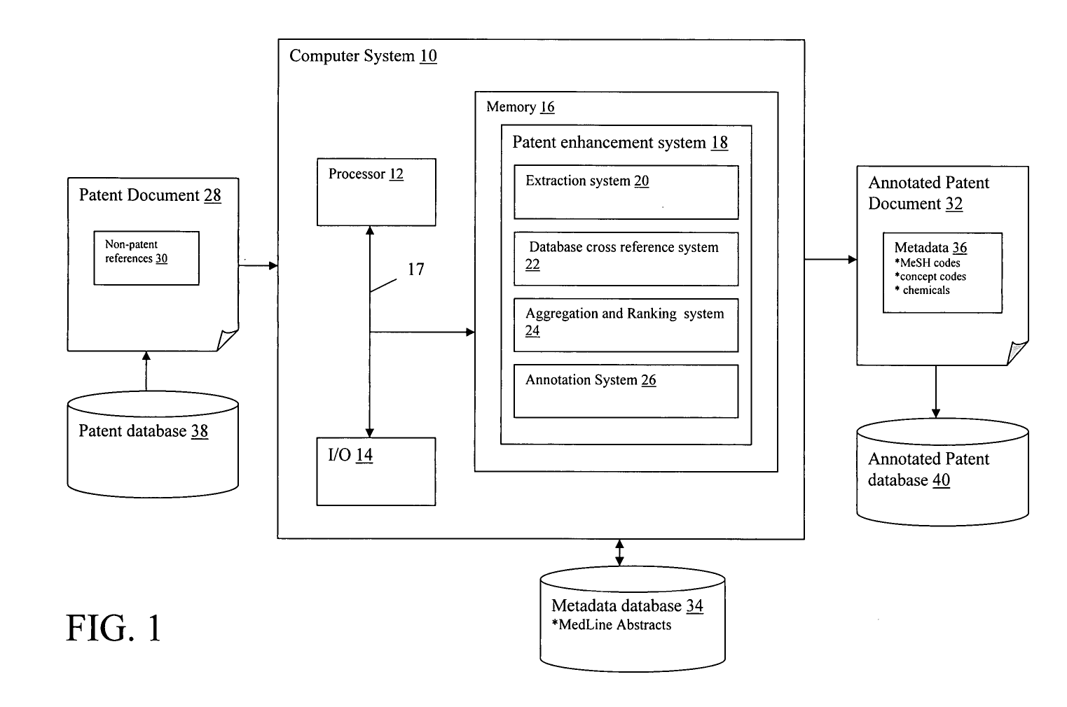

Referring to drawings, FIG. 1 depicts a computer system 10 having a patent enhancement system 18 that identifies non-patent references 30 in a patent document 28 and generates an annotated patent document 32 having metadata 36 that is derived from the non-patent references 30. In one illustrative embodiment, users can then search a database 40 of annotated patents using metadata search terms to improve patent searching capabilities. Note that patent document 28 and annotated patent document 32 may exist in in any format, including electronic, image, paper, etc. Also note that while the embodiments described herein generally relate to enhancing biotechnology related patents, it should be understood that invention could be applied to any field of technology.

Patents generally contain three types of references, US patents references, foreign patent references, and non-patent references. Non-patent references typically include scientific articles that provide details and background information regarding the patent on which they appear. As noted above, in the case of biotechnology, most scientific articles have been indexed via the National Library of Medicine (NLM), which provides a set of metadata for each article. This metadata is collected, stored and indexed in databases, such as that provided by MedLine, which stores an abstract for each such article. Medline's “indexed metadata” include MeSH data, concept codes, chemical structures, keywords, etc., related to those articles.

It is understood that while this illustrative embodiment is described with reference to a Medline database, the invention is not limited to a particular metadata database, and therefore could be implemented using any database, or databases, that provides indexed metadata derived from a set of documents or publications.

Patent enhancement system 18 includes: an extraction system 20 for extracting non-patent references 30 from the patent document 28; a database cross-reference system 22 for capturing any indexed metadata (e.g., MedLine abstracts) that exists in the metadata database (e.g., a MedLine database) for each extracted non-patent reference; an aggregation and ranking system 24 that aggregates and ranks different categories and/or pieces of metadata captured by the database cross-reference system 22; and an annotation system 26 that annotates the patent document 28 with the aggregated and ranked metadata. The result is an annotated patent document 32 that includes a set of metadata 36, such as MeSH codes, concepts codes, chemicals, etc. As noted, the resulting annotated patent document 32 could be stored along with other annotated patent documents in an annotated patent database 40.

Each of the above mentioned systems 20, 22, 24, and 26 could be readily implemented by one skilled in the art of database programming. For instance, electronic patent databases currently exist, which allows a user or process to specify fields within the patent to readily identify prior art reference. Such references could be readily parsed to distinguish patent versus non-patent references. An indexed metadata database 34, such as a MedLine database, could for example be loaded into a dB2 database. In one embodiment, an entire patent database 38 could be transformed into an annotated patent database 40 using the techniques described herein.

In a further illustrative embodiment, the metadata database 34 could be loaded as a separate star schema that is part of a larger patent data warehouse that also contains patent metadata, as well as the “full-text” of issued patent and published applications.

The aggregation and ranking system 24 could be implemented in any manner. For instance, if a patent lists multiple non-patent references that return the same piece of metadata, those instances of the metadata could be aggregated into a single listing with an increased rank of importance. Moreover, aggregation and ranking system 24 could identify “categories” of metadata that are deemed more important than others. Furthermore, aggregation and ranking system 24 could filter portions of the metadata, such that the process of annotating the patent document 28 may include only selected portions of the metadata information located in the metadata database 34.

Likewise, annotation system 26 may be implemented in any fashion. For instance, the metadata information may be stored in additional fields of a patent database.

It should be understood that any type of metadata could be used within the context of the present invention to annotate patents based on non-patent references. Illustrative types of metadata include MedLine qualifier codes, chemicals, molecular structures, MeSH codes, concept codes, classifications, ontologies, etc. Non-biotechnology related patents, such as software, mechanical, electrical, etc., could likewise be annotated in a similar fashion with domain specific metadata based on, e.g., existing or developed metadata ontologies and classifications.

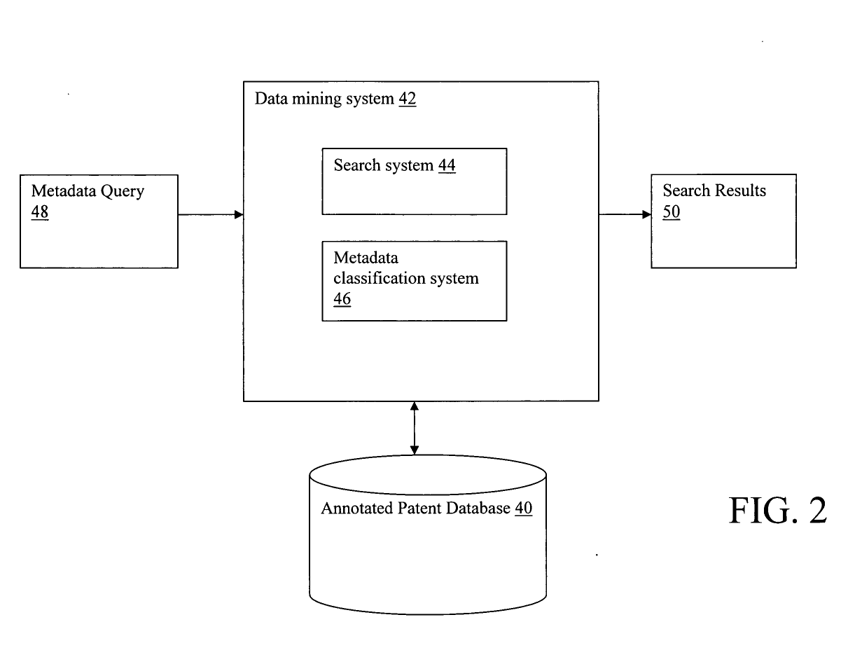

FIG. 2 depicts a data mining system 42 for exploiting the annotated patent database 40 of FIG. 1. Data mining system 42 includes a search system 44 and metadata classification system 46 that allows a user to enter a metadata query 48 to generate a set of search results 50.

In general, the computer system 10 of FIG. 1 (as well as the data mining system 42 of FIG. 2) may be implemented using any type of computing device, e.g., a desktop, a laptop, a workstation, a hand held device, etc., and may be implemented as part of a client and/or a server. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network 36 such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising patent enhancement system 18 and/or data mining system 42 could be created, maintained and/or deployed by a service provider that offers the functions described herein for customers. That is, a service provider could offer to provide patent annotations and/or data mining as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for enhancing a patent document, comprising:
an extraction system for extracting non-patent references from a patent document;
a system for cross-referencing an extracted non-patent reference with a metadata database to identify metadata information associated with the extracted non-patent reference; and
a system for annotating the patent document with the metadata information.

2. The system of claim 1, further comprising a system for aggregating and ranking metadata information.

3. The system of claim 1, wherein the metadata information consists of data selected from the group consisting of: MedLine qualifier codes, chemicals, molecular structures, MeSH codes, concept codes, and classifications.

4. The system of claim 1, further comprising an annotated patent database that includes a plurality of patents annotated with metadata information derived from non-patent references.

5. The system of claim 4, further comprising a data mining system for searching the annotated patent database with a metadata query.

6. A computer program product stored on a computer usable medium for enhancing a patent document, comprising:
program code configured for extracting non-patent references from a patent document;
program code configured for cross-referencing an extracted non-patent reference with a metadata database to identify metadata information associated with the extracted non-patent reference; and
program code configured for annotating the patent document with the metadata information.

7. The computer program product of claim 6, further comprising a system for aggregating and ranking metadata information.

8. The computer program product of claim 6, wherein the metadata information consists of data selected from the group consisting of: MedLine qualifier codes, chemicals, molecular structures, MeSH codes, concept codes, and classifications.

9. The computer program product of claim 6, further comprising an annotated patent database that includes a plurality of patents annotated with metadata information derived from non-patent references.

10. The computer program product of claim 9, further comprising a data mining system for searching the annotated patent database with a metadata query.

11. A method of enhancing a patent document, comprising:
extracting non-patent references from a patent document;
cross-referencing an extracted non-patent reference with a metadata database to identify metadata information associated with the extracted non-patent reference; and
annotating the patent document with the metadata information.

12. The method of claim 11, further comprising the step of aggregating and ranking the metadata information.

13. The method of claim 11, wherein the metadata information consists of data selected from the group consisting of: MedLine qualifier codes, chemicals, molecular structures, MeSH codes, concept codes, and classifications.

14. The method of claim 11, further comprising storing the annotated patent document in an annotated patent database that includes a plurality of patents annotated with metadata information derived from non-patent references.

15. The method of claim 14, further comprising the step of searching the annotated patent database with a metadata query.

16. A method for deploying patent enhancement application, comprising:
providing a computer infrastructure being operable to:
extract non-patent references from a patent document;
cross-reference an extracted non-patent reference with a metadata database to identify metadata information associated with the extracted non-patent reference; and
annotate the patent document with the metadata information.

17. Computer software embodied in a propagated signal for implementing a patent enhancement system, the computer software comprising instructions to cause a computer to perform the following functions:
extract non-patent references from a patent document;
cross-reference an extracted non-patent reference with a metadata database to identify metadata information associated with the extracted non-patent reference; and
annotate the patent document with the metadata information.
